(19) United States
(12) Patent Application Publication
(10) Pub. No.: US 2010/0192715 A1
(43) Pub. Date: Aug. 5, 2010

(54) MULTIPLE-ACTING LINEAR ACTUATOR

(75) Inventors: Guy Vauchel, Le Havre (FR); Pierre Baudu, Criquetot L'Esneval (FR)

Correspondence Address: CANTOR COLBURN, LLP, 20 Church Street, 22nd Floor, Hartford, CT, 06103, US

(73) Assignee: AIRCELLE, Gonfreville L'Orcher (FR)

(21) Appl. No.: 12/665,158

(22) PCT Filed: Mar. 28, 2008
(86) PCT No.: PCT/FR2008/000430

§ 371 Date: Dec. 17, 2009

(30) Foreign Application Priority Data
Jun. 19, 2007 (FR) 0704343

(51) Int. Cl. F16H 27/02

(52) U.S. Cl. 74/89.35

(57) ABSTRACT

The present invention relates to a multiple-acting linear actuator (100) intended to drive at least two elements capable of moving relative to a fixed element comprising a plurality of rod-forming concentric tubular bodies (103, 102, 104) engaged successively one inside the next via external and/or internal screw threads (105, 106, 107, 108), characterized in that one of the bodies is connected to rotational-drive means (109), the other bodies then together forming an internal and/or external transmission train, and in that said bodies are associated with selective lock-up means whereas the outermost bodies of the internal and/or external transmission trains are permanently prevented from rotating.

### TECHNICAL FIELD

The present invention relates to a telescopic linear actuator for moving a first element and a second element relative to one another and with respect to a fixed element, these three elements in particular belonging to a thrust reverser of a turbojet engine nacelle as described for example in the as yet unpublished French patent application filed under the No. 06.09265 and in the likewise as yet unpublished French application filed under the No. 06.05512, both filed in the name of the Applicant Company and incoproated herein by reference.

### BACKGROUND

An airplane is propelled by a number of turbojet engines each housed in a nacelle that also houses a collection of auxiliary actuating devices associated with its operation and for forming various functions when the turbojet engine is operating or not operating. These auxiliary actuating devices comprise, for example, a mechanical system for actuating thrust reversers.

A nacelle generally has a tubular structure comprising an air intake upstream of the turbojet engine, a central section intended to surround a fan of the turbojet engine, a downstream section housing thrust-reversal means and intended to surround the combustion chamber of the turbojet engine, and generally ends in a jet pipe, the outlet of which is situated downstream of the turbojet engine.

Modern nacelles are intended to house a bypass turbojet engine able, using the blades of the rotating fan, to generate a flow of hot air (also known as the primary flow) coming from the combustion chamber of the turbojet engine, and a flow of cold air (the bypass or secondary flow), which flows around the outside of the turbojet engine through an annular passage also known as a flow path, formed between a cowling of the turbojet engine and an internal wall of the nacelle. The two air flows are ejected from the turbojet engine via the rear of the nacelle.

The purpose of the thrust reverser is, when an airplane is coming into land, to improve the ability of the airplane to brake by redirecting forward at least some of the thrust generated by the turbojet engine. During this phase, the reverser obstructs the flow path for the cold flow and directs the latter toward the front of the nacelle, thereby generating a reverse thrust which adds to the braking of the wheels of the airplane.

The means used to perform this redirection of the cold flow vary according to the type of reverser. However, in all cases, the structure of a reverser comprises moving cowls that can be moved between, on the one hand, a deployed position in which they open up within the nacelle a passage intended for the diverted flow and, on the other hand, a retracted position in which they close off this passage. These cowls may perform a deflecting function or may simply activate other deflection means.

In the case of a cascade-type thrust reverser, the airflow is redirected by cascades of deflection vanes, the cowl having a simple function of sliding aimed at uncovering or covering these cascades of vanes, the translational movement of the moving cowl being along a longitudinal axis substantially parallel to the axis of the nacelle. Complementary blocking doors, also known as shutters, activated by the sliding of the cowling, generally allow the flow path to be closed off downstream of the cascade of vanes so as to optimize the redirection of the cold flow.

These shutters are generally pivot-mounted, via an upstream end, on the sliding cowl so that they pivot between a retracted position in which they, together with the moving cowl, ensure the aerodynamic continuity of the internal wall of the nacelle, and a deployed position in which, in a thrust-reversal situation, they are least partially close off the annular duct so as to divert a flow of gas toward the cascades of deflection vanes uncovered by the sliding of the moving cowl. The pivoting of the shutters is guided by link rods attached, on the one hand, to the shutter and, on the other hand, to a fixed point of the internal structure delimiting the angular duct.

French application 06.09265 aims to address the disadvantages whereby these link rods pass across the flow path.

### BRIEF SUMMARY

The present patent application seeks to provide a suitable double-acting actuator of simple design and which meets the requirement of maneuvering a configuration of shutters without a link rod as described in application FR 06.09265.

More specifically, the actuating of the moving cowl and the pivoting of the shutters needs to be performed simultaneously, but at different speeds.

The obvious solution is therefore to provide one dedicated actuator per moving part. However, a solution such as this is cumbersome and entails complex electronic or mechanical synchronizing of the actuating means.

The present invention therefore proposes a double-acting actuator, that is to say an actuator able to actuate each of the two moving parts with its own dynamics while at the same time requiring just one actuator drive member.

To do this, the invention includes a multiple-acting linear actuator intended to drive at least two moving elements relative to a fixed element, comprising a plurality of concentric tubular bodies forming rods and engaged in succession inside one another via external and/or internal screw threads, characterized in that one of the bodies is connected to rotational drive means, the other bodies then together forming an internal and/or external drive train, and in that said bodies are associated with selective lock-up means while the end most bodies of the internal and/or external drive trains are permanently prevented from turning.

Thus, by providing a single rotationally driven body able to transmit said rotational movement to one or more concentric bodies through mutually interacting screw threads, the various moving bodies are automatically synchronized through the screw threads. The relative sizing of the screw threads allows the speeds of relative translational movement of the bodies with respect to one another to be adapted from the starting point of an identical rotational drive speed.

Advantageously, the actuator comprises a base intended to be attached to the fixed element, and serving as a housing supporting the concentric bodies.

For preference, the actuator comprises an external body, a central body and an internal body, all three of them forming rods, the actuator being characterized in that the central body has an external first screw thread able to collaborate with a corresponding screw thread of the external body, and an internal second screw thread designed to collaborate with a corresponding screw thread of the internal body, one of the bodies being prevented from translational movement and able to be connected to suitable rotational drive means while the other two bodies, each intended to be connected to one of the moving elements that are to be driven, are free to effect translational movement but prevented from turning, with the exception of the scenario in which one of these bodies is the central body which is then associated with disengageable rotational lock-up means.

According to a first alternative form of embodiment, the external screw thread of the central body has a pitch that is longer (coarser) than the pitch of the internal screw thread. The speed of translational movement of the external body will therefore be higher than the speed of translational movement of the internal body.

According to a second alternative form of embodiment, the external screw thread of the central body has a pitch that is shorter (finer) than the pitch of the internal screw thread. The speed of translational movement of the external body will therefore be lower than the speed of translational movement of the internal body.

According to a third embodiment, the external and internal screw threads have identical pitches. The speeds of translational movement will then be identical.

According to a first embodiment of the invention, the body connected to the rotational drive means is the central body.

In such a case, the actuator according to the invention is perfectly suited to actuating a blocking shutter concurrently with a thrust reverser panel, as described previously.

For preference, the central body is intended to be connected to a moving thrust-reverser cowl while the external body is intended to be connected to means of driving the pivoting of a shutter.

Quite obviously, a configuration such as this can also be used for simultaneously actuating two moving parts relative to one another and with respect to a fixed part in instances where these two moving parts have different travels and different speeds of opening and of closing.

According to a second embodiment, the body connected to the rotational drive means is the external body.

This embodiment makes it possible to adapt the structure of the actuator previously described and adapt it to address the problems associated with actuating a variable nozzle, as described in document FR 06.05512, for example.

The problem with actuating a variable nozzle stems from the fact that this nozzle has to be maneuverable during various phases of flight when the thrust reverser is in the closed position.

Since the variable nozzle is mounted on the moving thrust-reverser cowl, it needs to be able to be driven at the same time as the latter, although the “variable nozzle” function that allows the outlet cross section of the nacelle to be adapted can be deactivated and is not used when the thrust reverser is activated.

Thus, by driving the actuator according to the invention through the agency of the external body, it is possible to achieve this synchronization in an easy way.

More specifically, when the moving cowl needs to be maneuvered, the central body is prevented from turning. It does not therefore transmit the rotational movement to the internal body, which will therefore be driven by the same movement as the central body.

When the moving cowl is in the closed position, the internal body connected to the variable nozzle can be actuated independently by disabling the rotational lock-up of the central body using the selective lock-up means.

In so doing, the central body then allows the rotational movement with which the external body is driven to be transmitted to the internal body which, prevented from turning, is given a corresponding translational movement.

For preference, the central body is intended to be connected to a moving thrust-reverser cowl while the internal body is intended to be connected to a moving nozzle with which said thrust reversal system is equipped.

Quite obviously, this same actuator can be used in other applications that address the same technical problem.

For preference, the disengageable rotational lock-up means take the form of a system of claws fixed to the central body and able to collaborate with corresponding teeth exhibited by the internal body.

Advantageously, the system of claws has elastic return means forcing said claws into their position of engagement with the teeth of the internal body. Thus, by default and in the absence of any specific command, only the nozzle part may be actuated.

For preference, the internal body can be translationally driven by engagement of the disengageable lock-up means with which the central body is equipped only when the variable nozzle is in a set position relative to the moving cowl.

### BRIEF DESCRIPTION OF THE DRAWINGS

The implementation of the invention will be better understood with the aid of the detailed description set out hereinbelow with reference to the attached drawing.

FIG. 1 is a schematic part view in longitudinal section of a thrust reverser according to application FR 06.09265, equipped with a moving cowl and with a deflection shutter.

FIG. 2 is a view in longitudinal section of a first alternative form of a first embodiment of an actuator according to the invention, in the retracted position.

FIG. 3 is a view in longitudinal section of the actuator of FIG. 3, in the deployed position.

FIG. 4 is a view in longitudinal section of a second alternative form of a first embodiment of an actuator according to the invention, in the retracted position.

FIG. 5 is a view in longitudinal section of the actuator of FIG. 4, in the deployed position.

FIG. 6 is a schematic sectional view of a moving thrust-reverser cowl in the closed position, equipped with a variable nozzle, in the cruising position, and actuated using an actuator according to a second embodiment of the invention.

FIG. 7 is a view of the system of FIG. 6 for driving the variable nozzle.

FIG. 8 is a view of the system of FIG. 6 showing the variable nozzle in a slightly retracted (short nozzle) position.

FIG. 9 is a view of the system of FIG. 6 showing a nozzle returned to the cruising position and preparing for the maneuvering of the moving cowl.

FIG. 10 shows a view of the system of FIG. 6 with opening of the moving cowl, the position of the variable nozzle being kept fixed with respect to this said cowl.

### DETAILED DESCRIPTION

FIGS. 1 to 5 show a first embodiment of an actuator according to the invention intended for actuating a moving cowl of a reverser equipped with a shut-off shutter.

FIG. 1 is a schematic part view in longitudinal section on a plane passing through cascades of deflection vanes, of a cascade-type thrust reverser equipped with a shut-off shutter as described in application FR 06.09265 in the thrust-reversal situation.

In the known way, the thrust reverser 1 depicted in FIG. 1 is associated with a bypass turbojet engine (not depicted) and comprises an external nacelle which, together with a concentric internal structure 11, defines an annular flow duct 10 for a secondary flow path.

A longitudinally sliding cowl 2 includes two semi-cylindrical parts mounted on the nacelle in such a way as to be able to slide along slideways (not depicted).

An opening fitted with cascades of fixed deflection vanes 4 is formed in the external nacelle of the thrust reverser 1. This opening, when the gases are providing direct thrust, is closed by the sliding cowl 2 and is uncovered, in a thrust-reversal situation, by a longitudinal translational movement in the downstream direction (with reference to the direction in which gases flow) of the sliding cowl 2.

A plurality of reversal shutters 20, distributed about the circumference of the cowl 2 are each pivot mounted, by a upstream end, about an axis of articulation (not visible) on the sliding cowl 2 so that they pivot between a retracted position and a deployed position in which, in the thrust-reversal situation, they shut off the annular duct 10 so as to deflect a stream of gas toward the opening fitted with the cascades of vanes 4. There is a seal (not depicted) at the periphery of each shutter 20 to isolate the flow flowing through the annular duct 10 from the flow external to the nacelle.

When the turbojet engine is operating in direct thrust mode, the sliding cowl 2 forms all or part of a downstream part of the nacelle, the shutters 20 then being retracted inside the sliding cowl 2 which closes off the opening fitted with the cascades of vanes 4.

The shutters 20 therefore ensure the external aerodynamic continuity of the annular duct 10.

In order to reverse the thrust from the turbojet engine, the sliding cowl 2 is moved into a downstream position and the shutters 20 pivot into the shut-off position so as to deflect the secondary or bypass flow toward the cascades of vanes 4 and form a reversed flow guided by the cascades of vanes 4.

As shown in FIG. 1, a slider 24 for driving a shutter (or driving two shutters 20 positioned on either side of the slider 24) is mounted such that it can move into lateral slideways 33 that guide translational movement and are formed in a structure of the sliding cowl 2.

The driving slider 24 is connected to a downstream end of the shutter 20 by a driving link 30 articulated to the shutter about an axis 31 and to the slider 24 about a transverse axis 26, such that a translational movement of the slider 24 in its guiding slideways 33 is accompanied by a pivoting of the link 30 and therefore of the shutter 20.

Here, the driving slider forms an intermediate moving portion 24 of a “telescopic” actuating cylinder 22 positioned along the longitudinal axis of the reverser.

This pneumatic, electrical or hydraulic actuating cylinder 22 comprises a tubular base 23 linked, fixed or ball-jointed to the external nacelle upstream of the reverser 1. The base 23 houses the driving slider 24 and an end rod 25, both mounted, independently of one another, with the possibility of axial sliding in the base 23 of the actuating cylinder 22.

A downstream end of the end rod 25 is connected to the sliding cowl 2 by a transverse drive axis 27.

The actuating cylinder 22 is operated in such a way as to drive the slider 24 in a translational movement in its guiding slideways 33 when the sliding cowl 2 is in an end phase of its translational travel in the downstream direction.

It will thus be understood that, according to this earlier embodiment, the moving cowl 2 and the shutter 20 are both able to move in the same phase and are therefore set in motion simultaneously although at different speeds. This therefore requires an additional mechanism for synchronizing the two rods 24, 25 of the telescopic actuating cylinder 22.

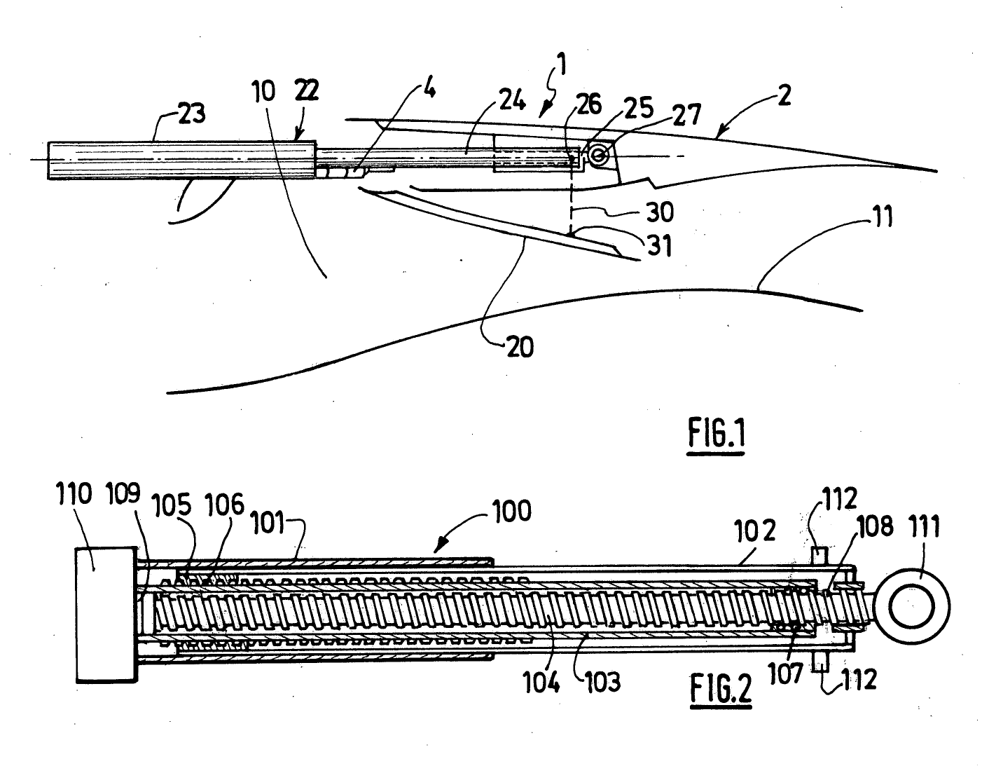

According to the present invention, there is therefore provided a self-synchronizing actuator. Such an actuator is depicted in FIGS. 2 to 5.

An actuator 100 according to the invention comprises a cylindrical sleeve 101 inside which there are housed three concentric bodies forming rods, namely an external body 102, a central body 103 and an internal body 104.

Each of the three bodies 102, 103, 104 is mechanically engaged with the adjacent body via screw threads.

More specifically, the external body 102 has an inside screw thread 105 engaged with a corresponding external screw thread 106 borne by the central body 103, the latter also having an internal screw thread 107 engaged with a corresponding external screw thread 108 borne by the internal body 104.

What is more, the central body 103 is prevented from translational movement and mounted such that it can turn on drive means 109 housed in a base 110 of the actuator.

The external body 102 and the internal body 104 for their part are prevented from turning but left free to move translationally. Rotational lock-up may be achieved simply by the attaching of the external body 102 and of the internal body 103 to the moving parts that they are respectively intended to drive, namely the moving cowl 2 and the shutter 20. For this, the internal body 104 ends in a securing eye 111 while the external body 102 has lateral drive pins 112.

The way in which an actuator such as this works is as follows. When the actuating means 109 are turning the central body 103, it imparts this movement to the external 102 and internal 104 bodies through the respective screw threads 105, 106 and 107, 108. Since the external 102 and internal 104 bodies are prevented from turning, the drive movement of the central body 103 is converted into a translational movement. The external body 102 and the internal body 104 are thus given a translational movement the direction of which is dependent on the direction in which the drive means are turning and the hand of the screw threads 105, 106 and 107, 108. Furthermore, the linear translational speed of the external 102 and internal 104 bodies is dependent on the pitch of each screw thread 105, 106 and 107, 108 although the rotational speed is identical.

From a single rotational drive of the central body 103, it therefore becomes possible to drive the translational movement of each of the bodies 102, 104 connected to a corresponding moving part, this drive being performed synchronously at relative speeds that can readily be adapted via the pitch of the screw threads 105, 106 and 107, 108.

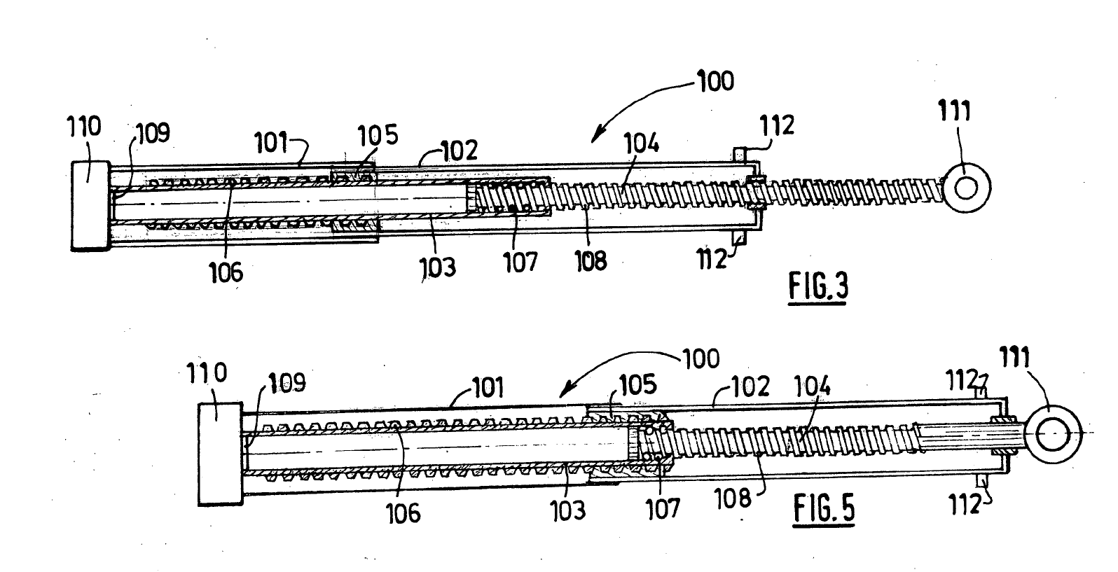

According to a first alternative form of embodiment depicted in FIGS. 2 and 3, the pitch of the external screw threads 105, 106 is shorter (finer) than the pitch of the internal screw threads 107, 108. It then follows that the external body will effect its translational movement at a speed lower than that of the internal body.

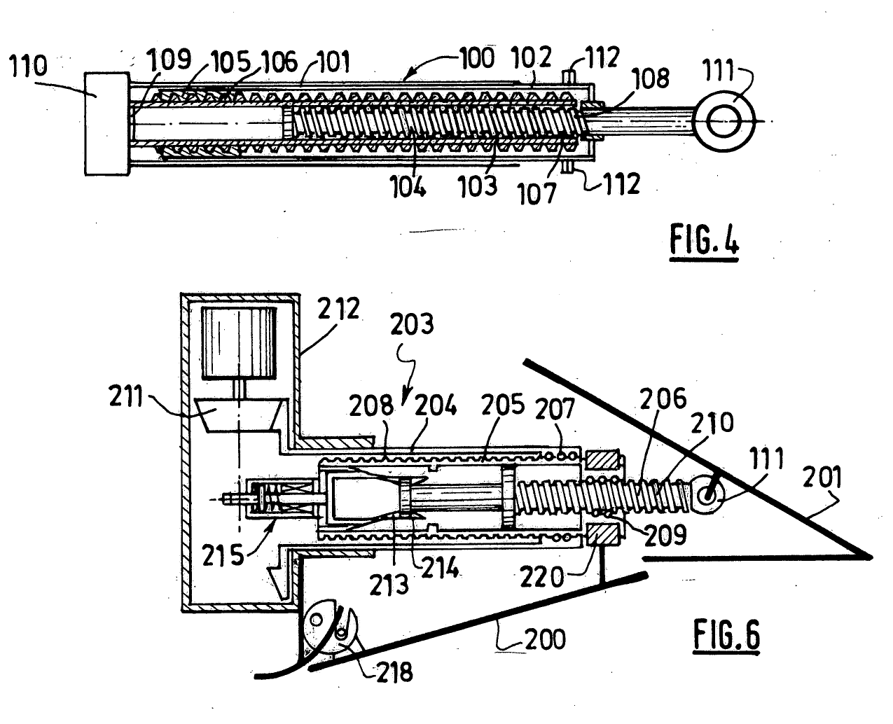

Conversely, according to a second alternative form of embodiment depicted in FIGS. 4 and 5, the pitch of the external screw threads 105, 106 is longer (coarser) than the pitch of the internal screw threads 107, 108. It then follows that the external body will effect its translational movement at a speed that is higher than that of the internal body.

Quite obviously, these parameters are adjusted by the person skilled in the art to suit the start and end point of each moving part.

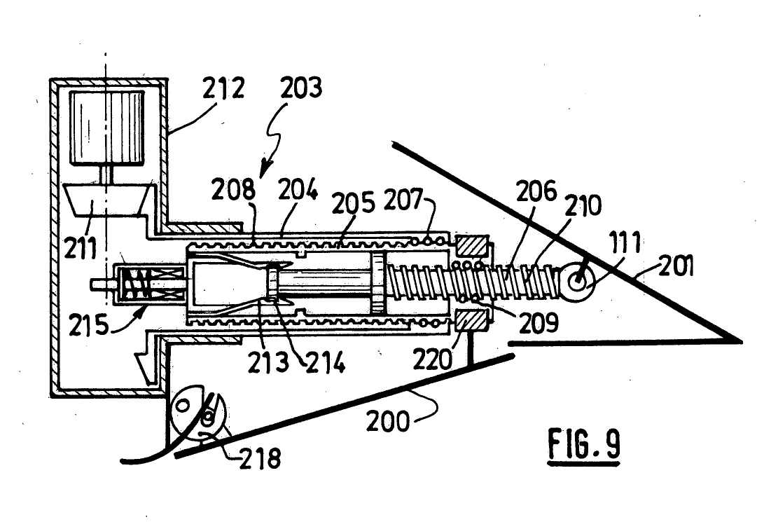

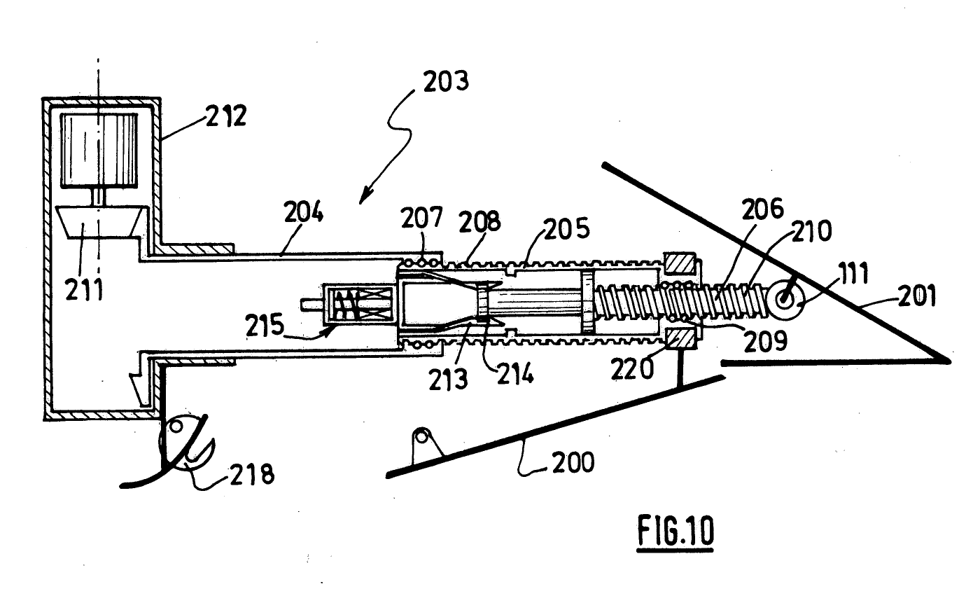

As mentioned previously, the fundamental structure of the actuator described can be adapted to allow the driving of a variable nozzle. An embodiment such as this is depicted in FIGS. 6 to 10.

These figures schematically show a moving thrust-reverser cowl 200 equipped with a nozzle end section 201 mounted such that it can move relative to the moving cowl in such a way as to form what is known as a variable nozzle.

Each moving part of this thrust-reversal system can be translationally driven using a single actuator 203 according to a second embodiment of the invention.

Like the actuator 100, the actuator 203 comprises an external body 204, a central body 205 and an internal body 206, all of these being concentric.

The external body 204 is mechanically engaged with the central body 205 and for this purpose has an internal screw thread 207 engaged with a corresponding external screw thread 208 of the central body 205.

Further, the central body 205 has an internal screw thread 209 engaged with a corresponding external screw thread 210 of the internal body 206.

The external body 204 is mounted fixed in terms of rotation movement but able to move in terms of translational movement and is connected to rotational drive means 211 housed in a casing 212 that forms a base of the actuator.

The internal body 206 for its part is capable of translational movement but prevented from turning.

Thus, the rotationally driven external body 204 transmits its movement to the central body 205 via the screw threads 208 and 209.

It then follows that if the central body 205 is prevented from turning, the movement of the external body 204 will be converted into a translational movement of the central body 205. The internal body 206 therefore receives no movement and remains stationary with respect to the central body 205. It therefore moves translationally simultaneously and at the same speed.

If the central body 205 is left free to turn, the movement of the external body 204 is then no longer converted into a translational movement but the rotational movement is imparted to the internal body 206 which, prevented from turning, is given an independent translational movement.

In order to provide the option as to whether to drive the internal body 206 by itself or together with the central body 205, the latter is equipped with selective translational lock-up means in the form of a claw coupling 213 mounted inside the central body 205 and having cutouts able to collaborate with corresponding teeth 214 borne by one end of the internal body 206.

These lock-up means are associated with control means 215 designed selectively to apply to the claws of the claw coupling 213 enough pressure that they can be pushed back away from the teeth 214.

With the internal body 206 prevented from turning, engagement of the claws 213 with the teeth 214 of this body allows the central body 205 to be prevented from turning.

Thus, when there is the wish to activate the thrust reverser, that is to say to actuate the moving cowl via the central body 205, the control means 215; of the electromagnetic type, are left retracted so that the claws 213 are engaged with the teeth 214. It then becomes possible simultaneously to drive the moving cowl 200 and the variable nozzle section 201 connected to the internal body 206.

Conversely, when there is a wish to activate only the variable nozzle 201, the control means 213 are actuated to move the claws 213 of the coupling away from the teeth 214, thus making the central body 205 free to turn.

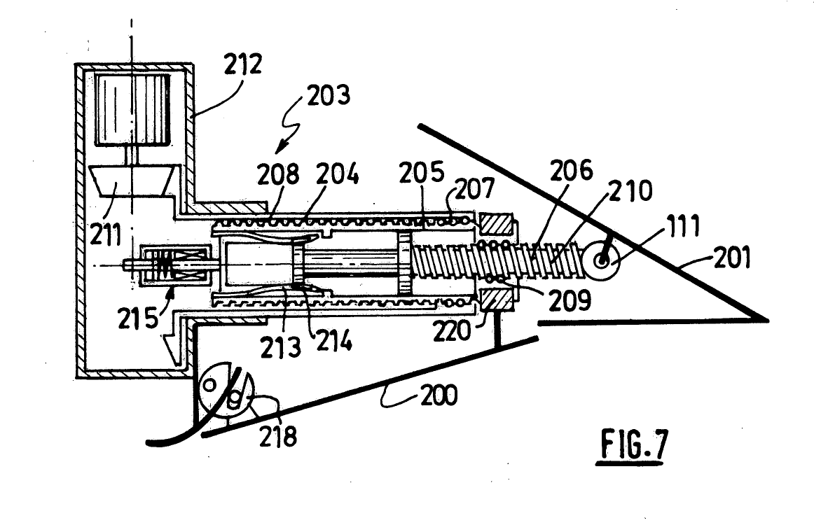

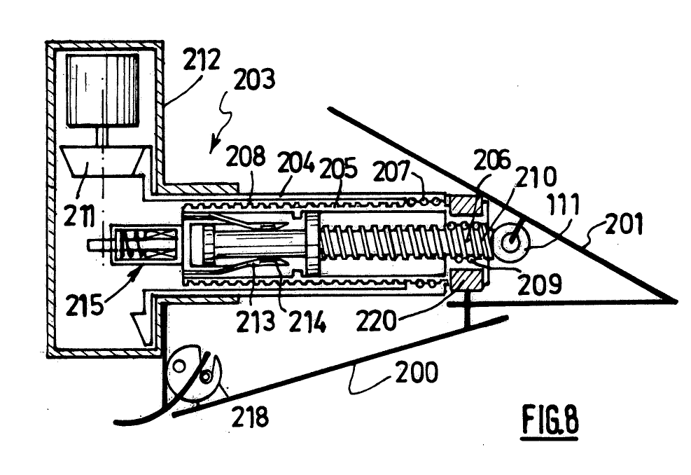

Actuation of the nozzle 201 is depicted in FIGS. 7 to 9.

Actuation of the moving cowl is depicted in FIG. 10 after the unlocking of the complementary means 218 of locking the moving cowl 200.

It will be noted that, in this particular instance, the moving cowl 200 can be driven only if the central body 205 is prevented from turning, that is to say if the claws 213 of the coupling are engaged with the teeth 214, which corresponds to a set position of the nozzle 201 relative to the moving cowl 200. If the nozzle 201 is in a retracted position or in a deployed position, it will be necessary first of all to return it to a normal position to allow the teeth 214 to engage with the claws 213 and lock up the central body 205 in terms of rotational movement.

Moreover, because the central body 205 is intended to be rotationally driven, it will be connected to the moving cowl 200 by ball means 220 such as a ring mounted on ball bearings for example.

Although the invention has been described using a specific embodiment, it is quite obvious that it is not in any way restricted thereto and that it encompasses all technical equivalents of the means described and combinations thereof where these fall within the scope of the invention.

1. A multiple-acting linear actuator intended to drive at least two moving elements relative to a fixed element, comprising:
a plurality of concentric tubular bodies forming rods and engaged in succession inside one another via external and/or internal screw threads;
wherein one of the bodies is connected to rotational drive means, the other bodies then together forming an internal and/or external drive train; and
wherein said bodies are associated with selective lock-up means while end most bodies of the internal and/or external drive trains are permanently prevented from turning.

2. The linear actuator as claimed in claim 1, further comprising a base intended to be attached to the fixed element, and serving as a housing supporting the concentric bodies.

3. The actuator as claimed in claim 1, wherein said plurality of concentric tubular bodies comprises three concentric bodies, including a central body, an external body and an internal body, all three forming rods, wherein the central body has an external first screw thread able to collaborate with a corresponding screw thread of the external body, and an internal second screw thread designed to collaborate with a corresponding screw thread of the internal body, one of the bodies being prevented from translational movement and able to be connected to suitable rotational drive means while the other two bodies, each intended to be connected to one of the moving elements that are to be driven, are free to effect translational movement but prevented from turning, except where one of these bodies is the central body which is then associated with disengageable rotational lock-up means.

4. The actuator as claimed in claim 3, wherein the external screw thread of the central body has a pitch that is longer than a pitch of the internal screw thread.

5. The actuator as claimed in claim 3, wherein the external screw thread of the central body has a pitch that is shorter than a pitch of the internal screw thread.

6. The actuator as claimed in claim 3, wherein the external and internal screw threads have identical pitches.

7. The actuator as claimed in claim 3, wherein the body connected to the rotational drive means is the central body.

8. The actuator as claimed in claim 7, wherein the internal body is intended to be connected to a moving thrust-reverser cowl while the external body is intended to be connected to means of driving a pivoting of a shutter.

9. The actuator as claimed in claim 3, wherein the body connected to the rotational drive means is the external body.

10. The actuator as claimed in claim 9, wherein the central body is intended to be connected to a moving thrust-reverser cowl while the internal body is intended to be connected to a moving nozzle with which said thrust-reversal system is equipped.

11. The actuator as claimed in claim 9, wherein the disengageable rotational lock-up comprises a system of claws fixed to the central body and able to collaborate with corresponding teeth exhibited by the internal body.

12. The actuator as claimed in claim 11, wherein the system of claws has elastic return means forcing said claws into a position of engagement with the teeth of the internal body.

13. The actuator as claimed in claim 10, wherein the internal body can be translationally driven by engagement of a disengageable lock-up means with which the central body is equipped only when the variable nozzle is in a set position relative to the moving cowl.
